(19) United States
(12) Patent Application Publication
(10) Pub. No.: US 2017/0132690 A1
(43) Pub. Date: May 11, 2017

(54) APPARATUS AND METHOD FOR FACILITATING A SOCIAL GROUP SHOPPING EXPERIENCE

(71) Applicant: Wal-Mart Stores, Inc., Bentonville, AR (US)

(72) Inventors: Jason R. Todd, Lowell, AR (US); Timothy W. Webb, Rogers, AR (US); Jared M. Kluver, Rogers, AR (US)

(73) Assignee: Wal-Mart Stores, Inc., Bentonville, AR (US)

(21) Appl. No.: 15/315,301

(22) PCT Filed: May 29, 2015
(86) PCT No.: PCT/US15/33201

§ 371 Date: Nov. 30, 2016

Related U.S. Application Data
(60) Provisional application No. 62/005,864, filed on May 30, 2014.

(51) Int. Cl. G06Q 30/06; G06Q 20/10

(52) U.S. Cl. CPC G06Q 30/0633; G06Q 20/102

(57) ABSTRACT

A method and apparatus for facilitating a social shopping experience via a group shopping user interface is provided. In one embodiment, a method includes the steps of: receiving a selection of a first item for potential addition to a virtual cart from a first user of a plurality of users forming a social shopping group comprising members who share a purchase cost of items in the virtual cart; providing an indication of the selection of the first item to the plurality of users for their feedback; receiving, in response to the indication, feedback on the first item from one or more of the plurality of users; adding the first item to the virtual cart based on the feedback from the one or more of the plurality of users, and initiating shared payment for the cost of one or more items in the virtual cart among the plurality of users.

This application claims the benefit of U.S. Provisional Application No. 62/005,864, filed May 30. 2014 which is incorporated in its entirety herein by reference.

### TECHNICAL FIELD

This invention relates generally to method and apparatus for facilitating group shopping experiences.

### BACKGROUND

Shoppers in a retail store often shop for other people. For example, one shopper may he shopping for his/her roommates who may wish to collectively decide what items should be purchased. Typically, if an in-store shopper is looking for a group's input during a shopping trip, the shopper would have to contact each of the group members individually to get the group member's opinion on each item for purchase. This process is cumbersome and time consuming as it may involve several phone calls and/or electronic messages to multiple persons. The in-store shopper typically also has to pay for the items first, and separately arrange to be reimbursed by multiple individuals for the cost of the items purchased during the shopping trip.

### BRIEF DESCRIPTION OF THE DRAWINGS

Disclosed herein are embodiments of apparatuses and methods for facilitating a social shopping experience with a group shopping user interface. This description includes drawings, wherein:

FIG. 1 is a block diagram of a system in accordance with several embodiments.

FIG. 2 is a block diagram of a group shopping server in accordance with several embodiments.

FIG. 3 is a flow diagram of an automated method in accordance with several embodiments.

FIGS. 4A and 4B illustrate a flow diagram of a group shopping experience in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein to facilitate a social shopping experience via a group shopping user interface. In a social shopping experience, a plurality of users form a social shopping group that decides what, to purchase and how to share the purchase cost. In some embodiments, each member of a social shopping group interacts through a group shopping user interface on a personal electronic device. A server communicating with one of the user devices is configured to receive a selection of a first item for potential addition to a virtual cart and to provide an indication of the selection of the first item to other members of the social group for their feedback. Upon receiving feedback on the first item from one or more of the plurality of users in response to the indication, the first item may be added to the virtual cart based on the feedback. The server may then initiate shared payment for the cost of one or more items in the virtual cart among the members of the social group.

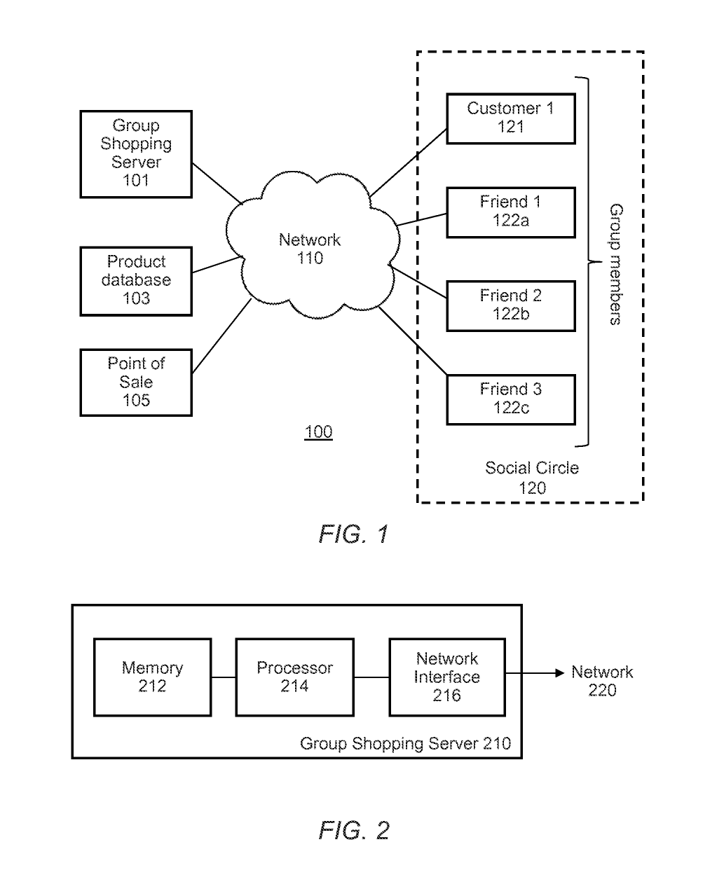

Referring now to FIG. 1, a system 100 for facilitating social shopping experience according to some embodiments is shown. The system includes a group shopping server 101, a product database 103, a retail point of sale (POS) 105, and user devices associated with members of the social circle 120, each communicating over a network 110. The social circle 120 may include two or more members, such as customer 1 121 and friends 1-3 122a-c. The social circle 120 may be any user defined group, such as a family, a group of gift givers, guests to a social event, participants of an activity, etc.

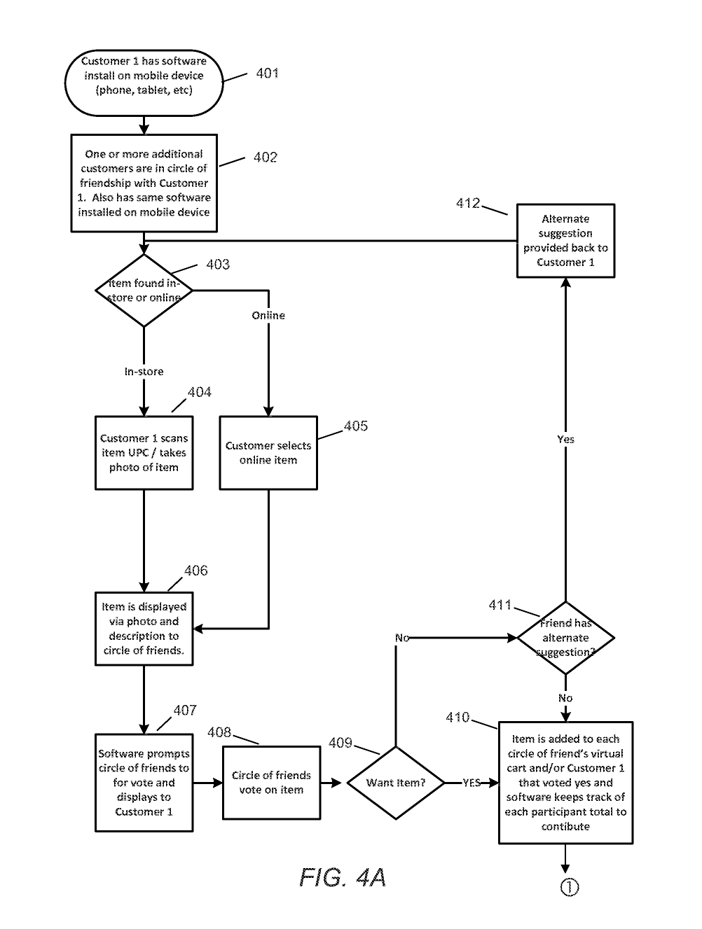

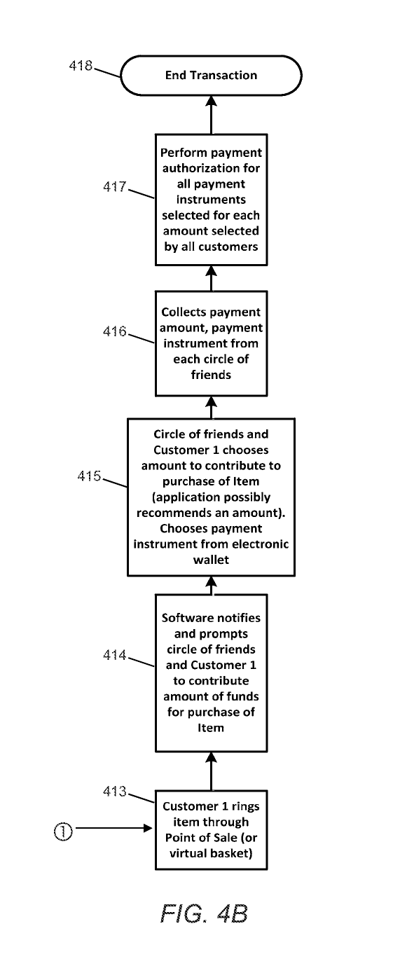

The group shopping server 101 communicates with user devices associated members of the social circle 120 through the network 110 to facilitate the group shopping experience. In some embodiments, the group shopping server 101 provides a group shopping user interface, such as a website accessible by the members of the social circle 120. In some embodiments, the group shopping server 101 interacts with a group shopping application (e.g., a group shopping “app”) installed on the user devices operated by the members of the social circle 120 which provides a group shopping user interface to facilitate group shopping. The group shopping server 101 may receive a selection of an item for potential purchase from at least one of the members of the social circle 120, provide an indication of the selection to the other members of the social circle 120, receive feedback on the items from some of the members, add an item to a virtual cart, and initiate shared payment for the purchase among the members. In some embodiments, the group shopping server 101 provides customer identity services to identify at least a primary shopper (e.g. customer 1) and members in the social circle 120. The customer identity service would allow users to be added or removed from the social circle 120 for the purpose of sharing the purchase cost of a group shopping experience. The user identity service may also maintain username and passwords for authenticating users and/or maintain a database of connections between users. A more detailed description of the functions performed by the group shopping server 101 is provided herein with reference to FIGS. 3 and 4A-B below.

The group shopping server 101 may communicate with the product database 103 to retrieve information associated products or items to provide to the users for feedback. For example, a customer 121 may scan the barcode of a product such as a bag of chips, and the group shopping server 101 may use the barcode to retrieve information such as product name, image, price, nutritional values, etc. from the product database 103. The product database 103 or another database may further provide information on related items (such as salsa that may be purchased along with the chips) or alternate items (another brand or type of chips) to the group shopping server 101 to provide to the users. In sonic embodiments, the user devices of the members of the social circle 120 can access the product database 103 directly to retrieve the information described above through the group shopping user interface. In some embodiments, the group shopping user interface allows the user to select an item for potential purchase and/or check an item's availability at a retail location through the product database 103 or an online store interface.

The group shopping server 101 may further communicate with the point of sale (POS) 105 to facilitate the purchase of items in a virtual cart. In some embodiments, the POS 105 is a checkout counter in a brick-and-mortar store. The POS may scan items gathered by the customer 1 121 for checkout. The group shopping server 101 may keep track of the items added to the virtual cart and provide the content of the virtual cart to the POS 105 to facilitate faster checkout. In some embodiments, the POS 105 may receive identifying information such as an ID number, a barcode, shopper's name, phone number, etc. from an in-store shopper and retrieve the content of the virtual cart from the group shopping server 101 to facilitate faster checkout. In some embodiments, the group shopping server 101 may also receive information from the POS 105, such as actual products scanned for purchase (which may be different from the content of the virtual cart), product prices, discounts applied, total cost for the items in the shopping cart, tax, and fees information etc. The information received from the POS 105 may be used to determine or suggest an amount each member of the social circle 120 should contribute towards the transaction. In some embodiments, the POS 105 maybe an online checkout system and the members of the social circle 120 may pay for the content of the virtual cart through authorizing an online payment. The some embodiments, the online payment system may provide a confirmation of payment receipt for the customer 1 212 in a brick-and-mortar store for checkout.

The product database 103 and the POS 105 may communicate with each other to update product information, product price, inventory, etc.

Members of the social circle 120 each may operate one or more user devices. The user devices may communicate with the group shopping server 101 through a website providing a group shopping user interface or through an installed application providing a social shopping user interface on the user device. The user device may be any consumer electronics device such as a personal computer (PC), a laptop, a Smartphone, a Smart TV, a tablet, and a wearable technology device, etc. The user devices are each configured to provide a group shopping user interface to the customers. In some embodiments, a primary shopper is provided a different version of the user interface as compared to the other contributing members in the social circle 120. For example, customer 1 121 may be an in-store shopper and the designated primary shopper, while friends 1-3 122a-c may be contributing to the purchase but are not in the store. The group shopping user interface provided to customer 1 may include options for selecting an item by scanning the barcode of the item or taking a picture of the item. In some embodiments, the user interface may allow customer 1 to edit a list of items for consideration and/or the content of the virtual cart while preventing other customers from performing similar actions. The user interface for the primary shopper may also allow customer 1 to initiate the checkout process when the virtual cart is deemed to be complete. On the other hand, the user interfaces for other contributing members may allow users to see a list of items for potential purchase, select one or more of the items, provide feedback on each of the selected items, and input payment information and/or authorization for the transaction. A more detailed description of the services provided by the group shopping user interface and the group shopping experience is provided herein with reference to FIGS. 3 and 4A-B below.

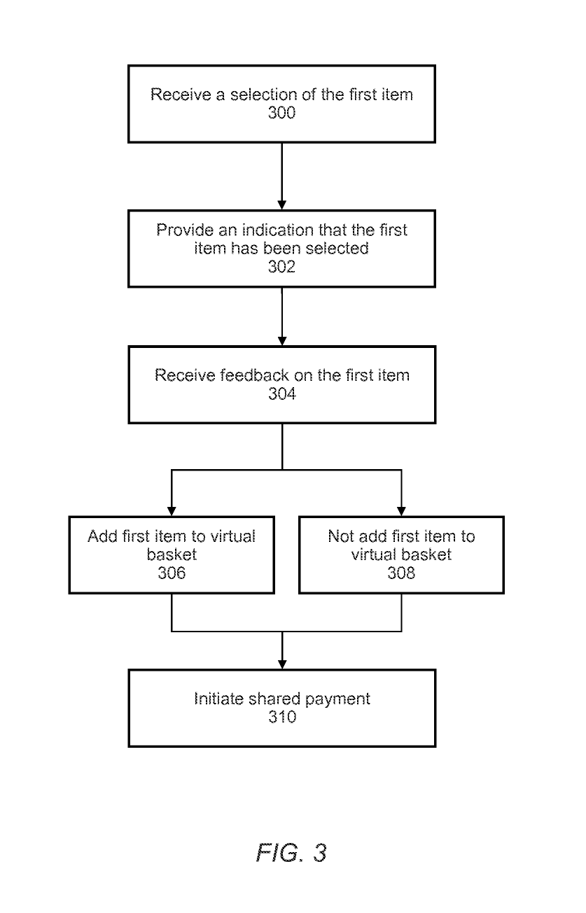

The network 110 may be the Internet, a local network, a wide area network, a private network, or a combination thereof. While the group shopping server 101, the product database 103, and the POS 105 are shown as separate components communicating through the network 112 in FIG. 2, each of these components may be implemented by the same physical device(s) as one or more of the other components. One of more components shown in FIG. 1 may also communicate through different wired and/or wireless connections and not necessarily through the network 110. For example, the group shopping server 101 and the product database 103 may be local to each other and communicate directly through a direct data connection or a local network. In another example, user devices for customer 1 121 and friend 1 122a may communicate through a local network or though short range communication such as near-field communication (NFC).

Referring now to FIG. 2, a block diagram of a server for facilitating social shopping experience according to some embodiments is shown. The group shopping server 210 includes a memory 212, a processor 214, and a network interface 216 for communicating with a network 220. The memory 212 may be any computer readable storage medium storing software and/or firmware code. This code includes executable instructions for causing the processor to perform one or more steps described in FIGS. 3 and 4A-B may be stored in the memory 212 or a remote storage. User log-in information, social connections, social circles, and/or payment instrument information may also be stored in the memory 212. The product database 103, the point of sale 105, and user devices used by members of the social circle 120 may include the same or similar components as those shown in FIG. 2.

Referring now to FIG. 3, a process for facilitating social shopping via a group shopping user interface according to some embodiments is shown. In step 300, a selection of the first item for potential additional to a virtual cart is received though a group shopping user interface displayed on a user device. The selection may be received from an in-store customer who scans the barcode of the first item or takes a photo of the first item using the group shopping user interface on his or her mobile device. The selection may also be received through a user entering a product descriptor such as a product name, product type, etc. into the group shopping interface. The selection may additionally be made through selecting the first item in an online product listing such as an online catalog or an online store. The online catalog or store may indicate inventory availability of the item at one or more specific retail locations and enable the selection of the product is available at the primary shopper's location. Generally, an in-store customer makes the selection of the first item. However, in some embodiments, the group shopping interface may allow any user to select an item for the group to consider for purchase.

In step 302, an indication that the first item has been selected is provided to user devices associated with members of a social group who will share the cost of the items purchased. In some embodiments, the indication includes information relating to the first item such as product name, product image, product price, product nutritional information, product rating, related products, alternate products, applicable discounts, etc. In some embodiments, the indication causes the user devices to provide a feedback interface through which users can input their feedback for the item. The feedback interface may allow the user to enter a yes or no vote or a score on the item for potential addition to a virtual cart. In some embodiments, the feedback interface allows the user to enter one or more of a free form comment, a selection of pre-populated comments, and/or a selection of an item from a number of alternate items. The indication may also include a pop-up notification, a text message, an email, a notification sound, etc.

In step 304, feedback on the first item is received. The feedback may he provided by one or more users through a feedback interface of the group shopping user interface as described in step 302 above. Example, the feedback may he a yes or no vote, a score, a free form comment, a pre-populated comment, or a selection of another or alternate item. In some embodiments, when feedback is received from one user, that user's feedback is displayed to others members of the social group. For example, the user interface may display the current number of yes or no votes on a particular item. In some embodiments, the feedback is only displayed to the primary shopper. In some embodiments, the system may enable a discussion on one or more items via the user interfaces to allow the users to discuss and ask questions about an item before voting yes or not, or giving the item a score.

In steps 306 and 308, an item is either added to a virtual cart or not added to the cart based on the feedback received in step 304. In some embodiments, the server or the user device automatically determines whether to add the item based on the feedback. For example, if the number of yes votes exceeds a threshold, the item is added to the cart. In another example, if the average score on an item exceeds a threshold, the item is added to the cart. In some embodiments, a server provides a summary of the feedback to a primary shopper, and the primary shopper decides whether to add the item to the virtual basket based on the feedback summary. In this case, the server receives a determination from the shopper that the first item is to be added to the virtual cart based on the feedback. The feedback summary may be a vote count, an average score, a list of comments, etc. In some embodiments, an item is added to the virtual cart if at least one yes vote is received from a user and only users who voted for the purchase of an item will share in the cost for the purchase of the item. In some embodiments, a separate virtual basket is associated with each member of the social circle. When a member votes yes on an item, the item is automatically added to his/her virtual basket to calculate the amount that user should contribute. After step 306, the process may return to step 300 to potentially add more items to the virtual cart. In some embodiments, additional items may be added anytime, including before a decision on whether to add a previously selected item is made. In which case, each user may be presented a list of items under consideration and can select each item to provide their feedback anal/or to add to their virtual cart.

In some embodiments, after an item is not added to a virtual basket in step 308, the item is removed from a list of items under consideration for purchase. In some embodiments, the item is moved to a rejected list from which users can select the item for reconsideration or change their feedback. For example, a user who voted no on an item may change their mind when there are no better alternatives available. In some embodiments, after step 308, a suggestion of alternate item(s) may be provided to the users. The suggestion of alternate item(s) may be provided by one of the users or by the server. For example, if corn chips is selected in step 300 and not added to the virtual cart in step 308, the user interface may automatically suggest other types of chips, such as potato chips or pretzels as alternative options. In some embodiments, the user interface allows the users to select one of the automatically provided alternate items for group consideration.

In step 310, shared payment for the cost of the items in the virtual cart is initiated. In some embodiments, step 310 begins when one or more members of the social group indicate that the virtual cart is complete. For example, when everything the group wishes to purchase has been added to the cart, payment may be initiated. In some embodiments, the user interface allows multiple members to provide feedback regarding the completion of the virtual cart. In some embodiments, users may be allowed to make contributions for the items they selected at any time. For example, if a user has added all the items he/she wishes to purchase, the user may make their contribution for those items before other members of the social group completes their item selection or feedback.

In some embodiments, the server determines how much each member should contribute to the purchase of the content of the virtual cart based on user configurable settings or other pre-set parameters. The determined amount for each member to contribute may be provided as a suggestion to the users. In some embodiments, the users can enter the amount they wish to contribute before or during step 310. In some embodiments, each member of the group is only asked to contribute toward items they voted for purchase.

In some embodiments, the server causes the user devices to prompt members of the social group for payment. The members may enter payment information such as payment instrument, authorization information, and payment amount to make their contribution. In some embodiments, the server or the user device may store a user's payment information and automatically processes the payment when the transaction is complete. In some embodiments, when prompted for payment, a user may provide authorization to contribute to the purchase with stored payment information.

In some embodiments, payment information is collected from multiple members of the social group and received for processing in an in-store checkout terminal or through an online payment system. In some embodiments, payment from multiple users is collated into fewer transactions or a single transaction with financial institution(s) for the purchase of the one or more items in the virtual cart. A financial institution may be a clearing house, a bank, or a credit card agency such as VISA and MASTERCARD. The aggregated payment allows a single transaction or a reduced transaction fee to be charged for the purchase instead having a transaction fee charged for each of payment from individual group members.

Referring now to FIGS. 4A-B, a group shopping and social payment process according to some embodiments is shown. In step 401, customer 1 has software install on his/her mobile device. The software may be a dedicated app or a general web browser. The mobile device may be a phone, a tablet, etc. In step 401, one or more additional users in a circle of friendship with customer 1 also have the same software installed on their mobile device. In this example, customer 1 may he an in-store shopper and generally referred to as the primary shopper. Customer 1 and his/her circle of friends may generally be referred to as a social group which members includes people who are not in the same retail store as customer 1. The software installed on the mobile devices may communicate with a group shopping server and provide a group shopping user interface to facilitate one of more of steps 411-417 as described below.

In step 403, the process splits depending on whether the item is found in-store of online. If the item is found in-store, in step 404, customer 1 scans the item's UPC (barcode) or take a photo of the item using their user device. If the item is found online, customer 1 or another member of the circle of friends can select the online item in step 405. The online selection may be performed through an online catalog or an online store.

In step 406, the item selected in either step 404 or 405 is displayed with a photo and a description of the item to the circle of friends. The photo and the description of the item may be provided by the group shopping server based on the UPC and/or the photo of the item from step 403. Other information about the item such as price, nutritional value, rating, applicable discount, etc. can also be displayed to users in step 406. In steps 407, the server also prompts the circle of friends for votes on the item and displays the votes to customer 1. In step 408 members of the circle of friends, which may also include customer 1, vote on the item.

In step 409, the process splits depending on if the item is wanted or not by the circle of friends. The decision of whether the item is wanted can be automatically performed by the system based on the vote received in step 408 or manually by customer 1. The system may determine that the item is wanted if the number of yes votes exceeds a threshold.

If the item is not wanted, in step 411, one of the friends may provide an alternate suggest for a different item to purchase. In step 412, the alternate suggestion is provided back to customer 1. Customer 1 can then select the item and began the process back at step 403. In some embodiments, after an alternate suggestion is provided at step 411, the process may proceed directly to step 406.

If the item is wanted, in step 410, the item is added to a collective virtual cart or to one or more individual virtual cart. For example, the item may only be added to the virtual carts of users who voted yes on the item such that only those who voted yes will contribute towards the payment of that item. In step 410, the server also keeps track of each participant's total to contribute based on either the content of the collective virtual cart or each member's individual virtual cart. For example, if five people voted yes for one item, the cost of that item may be split five ways. In other embodiments, the item is added to a collective virtual cart and circle of friends share in the total cost of any items added to the collective virtual cart.

In step 413, customer 1 rings the item/s through point of sale. The point of sale may be the checkout counter in a retail store and may scan items in a physical basket/cart to determine the actual total amount for the transaction. In some embodiments, the point of sale receives the content of the virtual cart to verify the items in the physical basket and/or to speed up the checkout process. In some embodiments, the point of sale may be an online payment system for processing the content of a virtual basket or virtual cart for online payment. In which case, customer 1 may initiate steps 414-417 while in a retail store. At the completion of the transaction at step 418, the online payment system provides a confirmation receipt to allow customer 1 to pass through the checkout counter in a brick-and-mortar store. In some embodiments, the point of sale is a combination of the in store and online checkout terminals. For example, items in the physical basket/cart may be scanned in store, while the payment is requested and processed online.

In step 414, software notifies and prompts the circle of friends and customer 1 to contribute amounts of fund for the purchase of one or more items added in steps 403-412. The notification may include a payment interface for entering payment information. In some embodiments, the notification request payment authorization for previously entered payment information.

In step 415, the circle of friends and customer 1 each chooses an amount to contribute towards the purchase the item(s). The system may recommend an amount for each member to contribute. The requested amount may be the same or different for each member of the circle of friends. In some embodiments, the recommended amount may be based on which items each member voted to purchase. In step 415, the system also receives a choice of payment instrument from the user. Payment instrument may be an electronic wallet, a credit card, a debit card, a bank transfer etc. The payment information may include other information associated with the payment instrument which is needed to authorize the payment, such as account number, address, phone number, etc.

In step 416, the system collects payment amount and payment instrument from each member in the circle of friends. In step 417, the system performs payment authorization for all payment instruments selected for each amount selected by all customers. In some embodiments, in step 417, the payments are collated such that they appear as a single transaction to each financial institution involved in the transaction such that a reduced transaction fee is charged for the transaction involving multiple payers. By collating individual payments into fewer or a single transaction, the transaction fees paid by the merchant may be reduced.

In some embodiments, at step 415, if the collected funds are not enough to cover the entire transaction, the system may request the members of the group to adjust their contribution amount. If sufficient funds are not gathered after the adjustment period or after a set time period, the primary shopper or the system may cancel the transaction.

In some embodiments, contribution is collected on an item by item basis. When a group member selects an item to add to the virtual cart, his/her share of the contribution is determined and approved before the item can be added to the virtual cart. An item is not added to the virtual cart until sufficient funds have been contributed for the purchase of that item. In some embodiments, if an item does not receive sufficient contribution, a member may choose to provide additional contribution to allow the item to be added to the virtual cart. During checkout, the system may automatically determine the amount to collect from each member by adding the amounts the member indicated he/she will contribute to each item in the virtual cart during the item selection process.

In the embodiment shown in FIG. 4A-B, one or more of steps 401, 404, 405, and 413 may be performed at least partially by customer 1, the primary shopper, interacting with the group shopping user interface on a user device. One or more of steps 406, 407, 410, 414, 415, 416, and 417 may be performed at least partially by software through the system facilitating the group shopping experience. The system for performing these steps may be one or more of the group shopping server 101, the product database 103, the point of sale 105, and user devices associated with members of the social circle 120 as shown in FIG. 1. In some embodiment, steps 406, 407, 410, 414, 415, 416, and 417 are performed by a group shopping server 101 interacting with group shopping user interfaces on the user devices operated by the members of circle of friends. One or more of steps 402, 408, and 415 are performed by at least partially by members of the circle of friends other than the customer 1 by interacting with the group shopping user interface.

In some embodiments, systems, apparatuses and methods are provided herein for facilitating a social shopping experience with a group shopping user interface. In one embodiment, a computer-implemented method performed by a processor-based device facilitating a social shopping experience via a group shopping user interface is provided. The method includes the steps of: receiving a selection of a first item for potential addition to a virtual cart from a first user of a plurality of users forming a social shopping group comprising members who share a purchase cost of items in the virtual cart; providing, via a network, an indication of the selection of the first item to the plurality of users for their feedback; receiving, via the network and in response to the indication, feedback on the first item from one or more of the plurality of users; based on the feedback from the one or more of the plurality of users, performing one of: (1) adding the first item to the virtual cart and (2) not adding the first item to the virtual cart; and initiating shared payment for the cost of one or more items in the virtual cart, among the plurality of users.

In one embodiment, an apparatus for facilitating group shopping is provided. The apparatus comprises a processor-based device facilitating a social shopping experience via a group shopping user interface; and a non-transitory computer readable medium storing a set of instructions executable by the processor-based device. The set of instructions is configured to cause the processor-based device to perform the steps of: receiving a selection of a first item for potential addition to a virtual cart from a first user of a plurality of users forming a social shopping group comprising members who share a purchase cost of items in the virtual cart; providing, via the network, an indication of the selection of the first item to the plurality of users for their feedback; receiving, via the network and in response to the indication, feedback on the first item from one or more of the plurality of users; based on the feedback from the one or more of the plurality of users, performing one of: (1) adding the first item to the virtual cart (2) not adding the first item to the virtual cart; and initiating shared payment for the cost of one or more items in the virtual cart among the plurality of users.

In one embodiment, a computer-implemented method by a processor based device facilitating a social shopping experience via a group shopping user interface is provided. The method includes the steps of: receiving a selection of a plurality of items for potential addition to a virtual cart from one or more of a plurality of users forming a social shopping group comprising members who share a purchase cost of selected items in the virtual cart; providing, via the network, an indication of the selection the plurality of items to the plurality of users for their feedback; receiving, via, the network and responsive to the providing the indication of the selection step, feedback on one or more of the plurality of items from one or more of the plurality of users; adding, one or more items of the plurality of items to the virtual cart; and initiating shared payment for the cost of the items in the virtual cart among the plurality of users.

Those skilled in the art will recognize that a wide variety of other modification, alterations, and combinations can also be made with respect to the above described embodiments without departing from the scope of the invention, and that such modifications, alterations, and combinations are to be viewed as being within the ambit of the inventive concept.

What is claimed is:

1. A computer-implemented method comprising:
by a processor-based device facilitating a social shopping experience via a group shopping user interface:
receiving a selection of a first item for potential addition to a virtual cart from a first user of a plurality of users forming a social shopping group comprising members who share a purchase cost of items in the virtual cart;
providing, via a network, an indication of the selection of the first item to the plurality of users for their feedback;
receiving, via the network and in response to the indication, feedback on the first item from one or more of the plurality of users;
based on the feedback from the one or more of the plurality of users, performing one of:
(1) adding the first item to the virtual cart and
(2) not adding the first item to the virtual cart; and
initiating shared payment for the cost of one or more items in the virtual cart among the plurality of users.

2. The method of claim 1 further comprising: determining, with the processor-based device, whether the first item is to be added to the virtual cart based on the feedback.

3. The method of claim 2, wherein the feedback comprises yes or no votes and the first item is added to the virtual cart if the number of yes votes is greater than a predetermined threshold.

4. The method of claim 1 further comprising receiving a determination from one of the plurality of users that the first item is to be added to the virtual cart based on the feedback.

5. The method of claim 1, wherein the selection of the first item is performed by one or more of: scanning a barcode of the first item at a retail store, taking a photo of the first item, entering a product descriptor of the first item in the group shopping user interface, and selecting the first item in an online product listing.

6. The method of claim 1, wherein the feedback comprises one or more of a free form comment, a selection of pre-populated comments, and a selection of an item from a plurality of alternate items performed through the group shopping user interface.

7. The method of claim 1, further comprising: in the event that the first item is not added. to the virtual cart, providing a suggestion for one or more alternate items to the plurality of users for feedback.

8. The method of claim 1, further comprising: determining an amount for each of the plurality of users to contribute toward the payment for the one or more items in the virtual cart.

9. The method of claim 1, further comprising: prompting the plurality of users for payment for the one or more items in the virtual cart.

10. The method of claim 1, further comprising: processing the virtual cart for online payment.

11. The method of claim 1, wherein the virtual cart is configured to be processed for payment in a retail store checkout terminal.

12. The method of claim 1, further comprising:
receiving payment information from the plurality of users; and
aggregating payment from the plurality of users into a single transaction with a financial institution for the purchase of the one or more items in the virtual cart.

13. An apparatus for facilitating group shopping comprising:
a processor-based device facilitating a social shopping experience via a group shopping user interface; and
a non-transitory computer readable medium storing a set of instructions executable by the processor-based device and configured to cause the processor-based device to perform the steps of:
receiving a selection of a first item for potential addition to a virtual cart from a first user of a plurality of users forming a social shopping group comprising members who share a purchase cost of items in the virtual cart;
providing, via the network, an indication of the selection of the first item to the plurality of users for their feedback;
receiving, via the network and in response to the indication, feedback on the first item from one or more of the plurality of users;
based on the feedback from the one or more of the plurality of users, performing one of:
(1) adding the first item to the virtual cart
(2) not adding the first item to the virtual cart; and
initiating shared payment for the cost of one or more items in the virtual cart among the plurality of users.

14. The apparatus of claim 13, wherein the processor-based device further performs the step of: determining whether the first item is to be added to the virtual cart based on the feedback.

15. The apparatus of claim 14, wherein the feedback comprises yes or no votes and the first item is added to the virtual cart if the number of yes votes is greater than a predetermined threshold.

16. The apparatus of claim 13 wherein the processor-based device further performs the step of: receiving a determination from one of the plurality of users that the first item is to be added to the virtual cart based on the feedback.

17. The apparatus of claim 13, wherein the selection of the first item is performed by one or more of: scanning a barcode of the first item at a retail store, taking a photo of the first item, entering a product descriptor of the first item in the group shopping user interface, and selecting the first item in an online product listing.

18. The apparatus of claim 13, wherein the feedback comprises one or more of a free form comment, a selection of pre-populated comments, and a selection of an item from a plurality of alternate items performed through the group shopping user interface.

19. The apparatus of claim 13, wherein, in the event that, the first item is not added to the virtual cart, the processor-based device further performs the step of providing a suggestion for one or more alternate items to the plurality of users for feedback.

20. The apparatus of claim 13, wherein the processor-based device further performs the step of: determining an amount for each of the plurality of users to contribute toward the payment for the one or more items in the virtual cart.

21. The apparatus of claim 13, wherein the processor-based device further performs the step of: prompting the plurality of users for payment for the one or more items m the virtual cart.

22. The apparatus of claim 13, wherein the processor-based device further performs the step of: processing the virtual cart for online payment.

23. The apparatus of claim 13, wherein the virtual cart is configured to he processed for payment in a retail store checkout terminal.

24. A computer-implemented method comprising:
by a processor based device facilitating a social shopping experience via a group shopping user interface,
receiving a selection of a plurality of items for potential addition to a virtual cart from one or more of a plurality of users forming a social shopping group comprising members who share a purchase cost of selected items in the virtual cart;
providing, via the network, an indication of the selection the plurality of items to the plurality of users for their feedback;
receiving, via the network and responsive to the providing the indication of the selection step, feedback on one or more of the plurality of items from one or more of the plurality of users;
adding, one or more items of the plurality of items to the virtual cart; and
initiating shared payment for the cost of the items in the virtual cart among the plurality of users.
